(19) United States
(12) Patent Application Publication
(10) Pub. No.: US 2010/0012427 A1
(43) Pub. Date: Jan. 21, 2010

(54) MOBILE ANCHORING AND FALL PREVENTION DEVICE

(76) Inventor: Xavier Julliard, Orlienas (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/520,422

(22) PCT Filed: Dec. 19, 2007
(86) PCT No.: PCT/FR07/02108

§ 371 Date: Jun. 19, 2009

(30) Foreign Application Priority Data
Dec. 21, 2006 (FR) 06 11172

(51) Int. Cl. E04G 21/32; E06C 7/18; E04G 21/00

(52) U.S. Cl. 182/82

(57) ABSTRACT

This device makes it possible to ensure the security of workers of any trade who operate from the inside of a building, on a wall, through a bay in said wall, while in the vicinity of empty spaces and without damaging the inner or outer existing structures (floor, wall, ceiling), characterized in that it comprises:

According to the invention, the device comprises:
a rigid structure (7, 10, 12) to be placed opposite the bay;
two arms (15) connected to the upper part of the structure (7, 10, 12), intended to bear on the wall, above the bay and on either side thereof, and
an anchoring point (16) integral with said structure (7, 10, 12), located at the upper portion thereof.

The present invention concerns a method and a device for temporary and transportable anchoring, making it possible to attach personal protective equipment (PPE), fall prevention safety system.

The present invention also concerns a device for securing work in front of a door, balcony or window ledge due to the height at which it is located above the ground.

Work on window ledges, balcony ledges or other work at heights near the outside poses serious safety problems given the risks of operators falling. These risks are particularly present due to the height at which the openings are found above the ground.

These risks are also present when it is impossible to use a platform from the outside, or a work structure such as scaffolding.

As fixed anchoring element, we know structural anchors making it possible to connect fall prevention personal protective equipment. We recall that a structural anchor is an element durably fixed on a structure to which it is possible to attach PPE. Their placement takes a long time and they require a waiting time before use if chemical sealing is used, in addition to causing damage to the facades.

As mobile anchoring element, we also know an aluminum ring requiring two fastenings by penetrating a wall near the worksite. One recalls that an anchoring point is an element to which personal protective equipment can be attached after installation of the anchoring device. This anchoring point is generally a ring or any other means resistant enough to absorb the fall of an operator connected thereto via PPE. They cause damage and require a long time to place.

As mobile anchoring element, we also know a door or window bar. It is placed through a door or a window opposite the direction of the fall risk. A ring at the center of the bar enables hooking of PPE connected to the operator. It can be used by one or two people depending on the width of the door. In case of operator fall, the bar stops the fall. Its drawbacks are that: the mooring is lower than the operator, which results in reducing, in case of fall, the stress exerted on the rope and the mooring; the rope goes through the entire site, even the ground, causing a bother for the operator; the door is not always facing the worksite, which makes its use impossible in many scenarios.

Fatal accidents occur because all currently known devices on the work market have serious drawbacks in terms of placement, complexity, installation cost, installation time, specific adaptation to certain worksites for which they do not work; in addition, most of these devices indeed require alterations such as boring into walls making it possible to secure an anchoring, which the owners of the sites refuse.

The operators' security is not always ensured when the duration of the work at a height is short-lasting, or if the work takes less time than the placement of the security devices existing today. They opt for the fall risk rather than for safety.

In summary, the known devices are so unsuited, long to implement, restrictive, or damaging for the sites that the workers working at heights do not use any security measures, thereby taking the risk of a fall.

Documents AE-387 143 and DE 93 18 317 also describe devices which can be used in this application but are not satisfactory.

The present invention aims to resolve all of the drawbacks of the existing devices.

The mobile anchoring and fall prevention device makes it possible to ensure the security of workers of any trade who operate from the inside of a building, on a wall, through a bay in said wall, while in the vicinity of empty spaces and without damaging the inner or outer existing structures (floor, wall, ceiling).

According to the invention, this device comprises:
a rigid structure to be placed opposite the bay;
two arms connected to the upper part of the structure, intended to bear on the wall, above the bay and on either side thereof, and
an anchoring point integral with said structure, located at the upper portion thereof.

The device according to the invention makes it possible to resolve the drawbacks of the existing devices, in that it operates perfectly in all scenarios and is quickly installed. It is usable immediately after its installation. It is installed in less than two minutes and enables all work which has a fall risk for the operator without it. It is particularly adapted to be able to perform all types of work at heights above the ground:
inside a building,
outside a building,
upright on a window ledge
inside a site, on a stepladder close to an open window.

It makes it possible to avoid using a structural or mobile anchoring requiring mechanical fixing, using a platform from the outside of the building, a scaffolding, a ladder.

Potentially usable by:
operators repairing defective rolling slat blinds, installing work outside or near the outside.
window washers,
operators installing equipment on an outer facade,
operators working on a ladder inside or outside, or on a stepladder inside.
all operators having to perform work at a height not allowing the installation of structural anchoring points, the use of scaffolding or a platform. Non-exhaustive list.

The aim of the invention is thus to propose a method and a device for transportable temporary anchoring, with a particularly simplified and quick, secure, efficient, non-damaging installation for the site where it is installed, with great freedom of choice of the installation site.

Said structure can comprise a single post intended to rest against the floor of the room in which the work is taking place and against the ceiling of this same room, said post being equipped with means for adjusting its length so as to apply its ends tightly against this floor and this ceiling, respectively.

Alternatively, said structure can comprise two lateral posts intended to rest against the floor and at least one crosspiece connecting these two posts to each other.

Said means for adjusting the length of said single post comprise:
at least two telescopic elements forming said post, able to be secured in a determined position in relation to each other, in particular by a system of holes arranged in these telescopic elements and at least one key, said determined position being such that, in this position, said post has a length slightly smaller than the distance separating the floor from the ceiling of the room where the work is taking place;
means for making fine adjustments to the length of said post, with the possibility of tightening, acting at the level of at least one end of this post, these adjustment means making it possible to achieve tight application of the ends of the post against the floor and the ceiling, respectively.

These fine adjustment means may in particular be of the stretching screw or turnbuckle type.

Advantageously,
at least one arm is mounted pivoting in relation to the structure;
the device comprises at least one portion engaged on a post of the structure with the possibility of sliding;
the device comprises a spacer connected pivotingly to said arm and this sliding piece, and
the device comprises a part secured on said post, forming a stop against which said sliding piece abuts in the deployed position of said arm.

Preferably, each post of the structure comprises a bearing pad against the surface on which it is intended to rest.

Advantageously, each arm comprises, at its end opposite said structure, a bearing pad against the wall comprising the bay, articulated in relation thereto.

According to another aspect of the invention, the two arms are, on the side opposite said structure, connected to each other by a cable, which limits any possibility of separation of one arm in relation to the other.

This cable can, at its central part, be connected to an elastic tightener facilitating folding of this cable during folding of the arms in relation to said structure.

The device can comprise rigid elements able to bear on the edges defining the bay, in particular deployable inside the bay, the additional structure formed by these rigid elements being connected to said structure of the device. Additional stabilization of the device is thus realized and lifting of loads through the bay can be done.

Said additional structure can comprise at least one bar designed to bear on one of the edges defining the bay and preferably at least two bars, at least one of which is designed to bear against a lower edge defining the bay and the other of which is designed to bear against an upper edge defining the bay. At least one of the bars of said additional structure is advantageously adjustable in length.

The device can also comprise a console including a floor and a railing designed to be placed on the outside the bay, this console being connected to the rest of the device by at least one arm and/or at least one cable.

When said means for adjusting the length of said single post comprise at least two telescopic elements, the device advantageously comprises:
a lower base on which one of the telescopic elements is mounted, with the possibility of sliding in relation to this base,
a spring inserted between this base and this telescopic element,
a pedal mounted pivoting on the base, and
a rod connecting the pedal and the telescopic element.

Actuating the pedal thus makes it possible, via said rod, to cause the telescopic element to slide vertically against the elastic force of the spring to enable easy returning of this telescopic element to a determined sliding position in relation to the adjacent telescopic element. This determined sliding position can in particular be that in which the holes comprised by one of the telescopic elements are opposite the holes comprised by the other telescopic element, so as to make it possible to facilitate the insertion through these respective holes of a pin for immobilizing one telescopic element in relation to the other.

### DESCRIPTION

Light structure, assemblable and disassemblable made in aluminum or steel, with circular, square, rectangular or other section, which is made up of three or four elements depending on the height under the ceiling of the worksite.

It is a structure bearing on four points: one on the floor, two against the wall and a fourth point vertically opposite the point on the floor against the ceiling, this last point not being essential.
the first bearing point, on the floor, very pulled back in relation to the inner wall, leaves a usable work space for placement of carpentry, installation of a stepladder, scaffolding, . . . of the material necessary for the worksite.
the two bearing points against the wall are positioned on either side of the bay at eye level, close to the ceiling.
a vertical blocking system immobilizes the system.

Operation and Placement:

The appended drawings illustrate the invention:

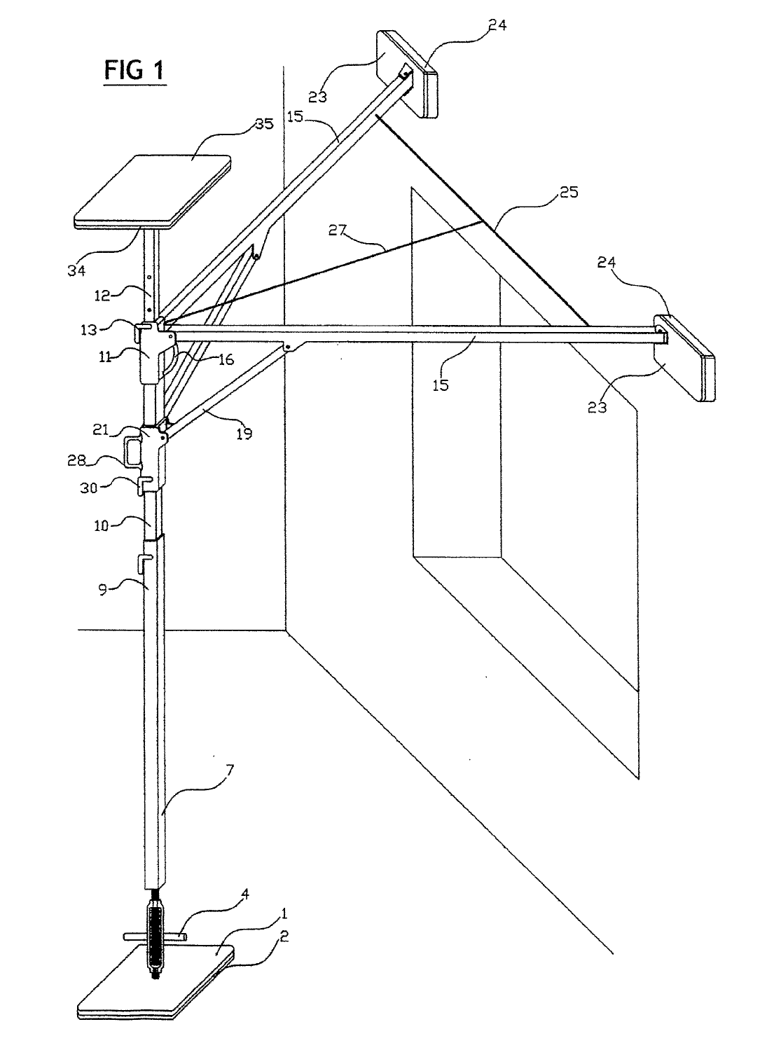

FIG. 1: complete perspective view of the device according to the invention.

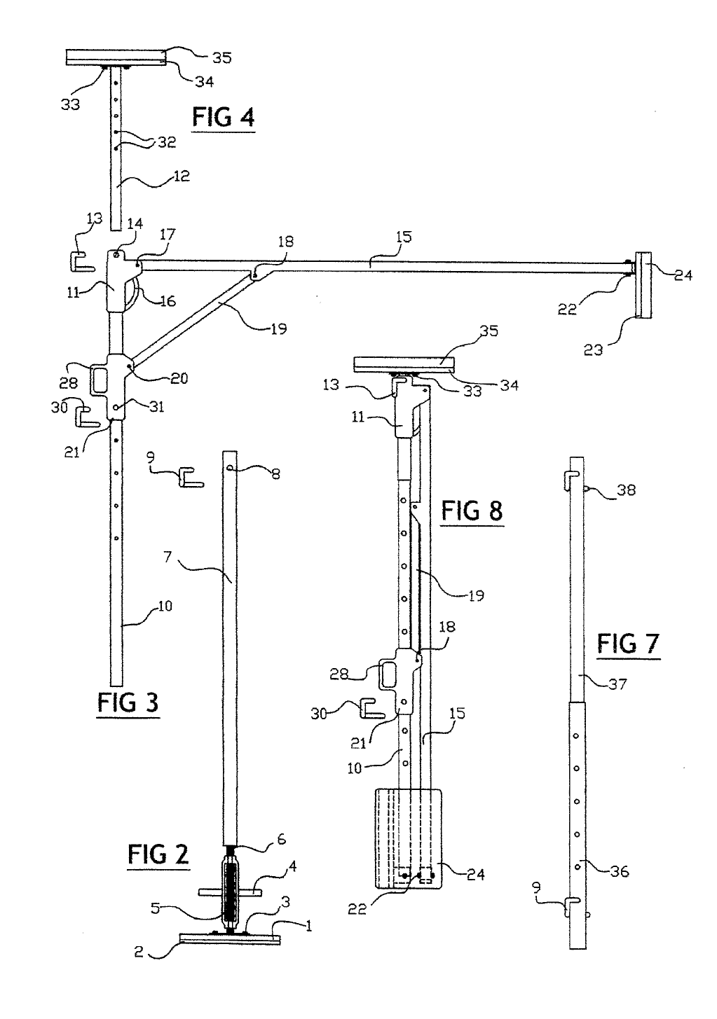

FIG. 2: side view of the lower portion of the device according to the invention.

FIG. 3: side view of the upper portion of the device according to the invention.

FIG. 4: side view of the raising part of the device according to the invention.

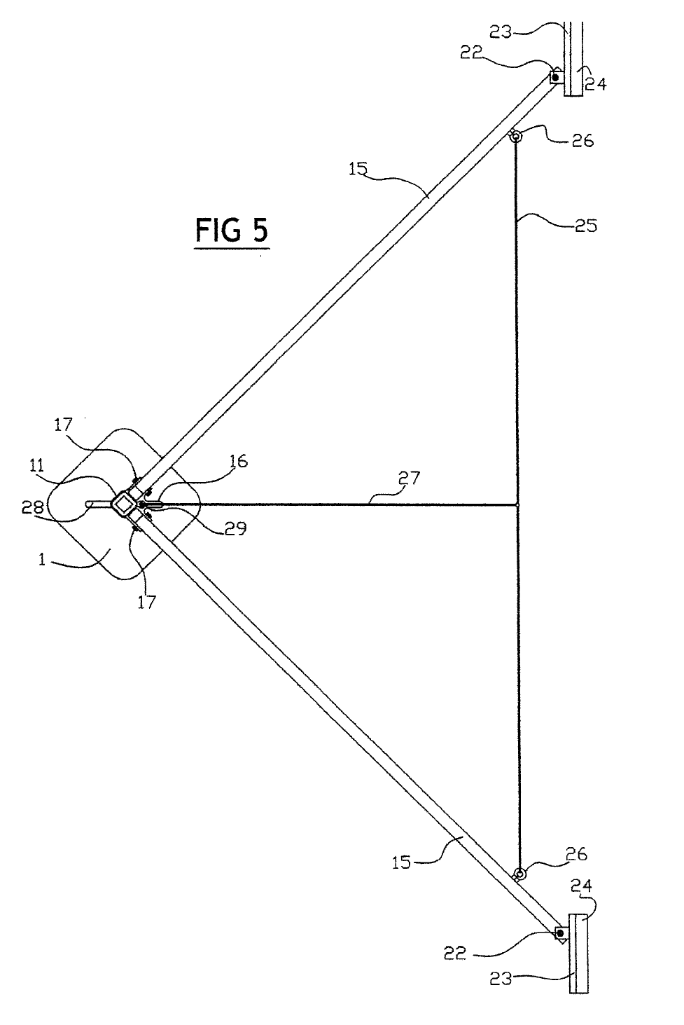

FIG. 5: top view of the of the device according to the invention without the raising part.

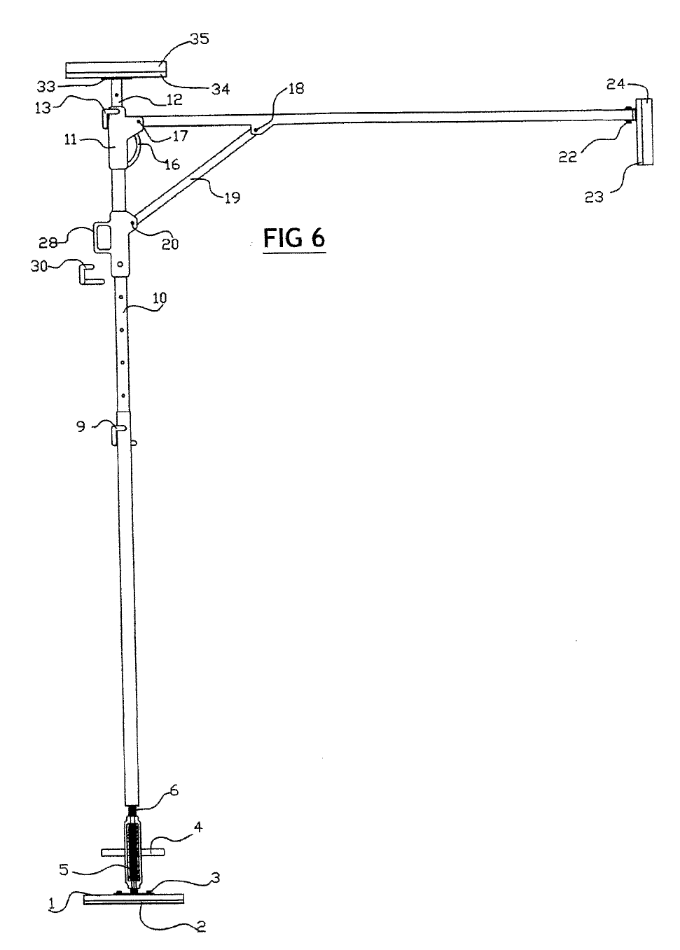

FIG. 6: complete side view of the device according to the invention.

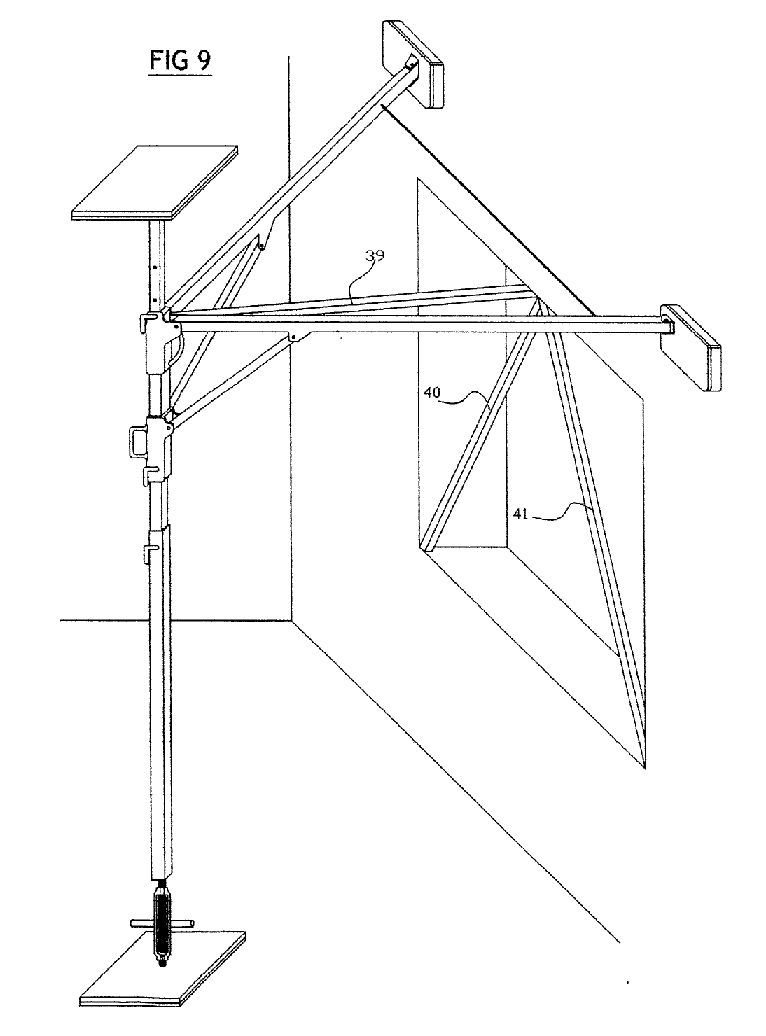

FIG. 7: side view of the extension of the device according to the invention.

FIG. 8: side view of the upper portion folded.

FIG. 9: perspective view of the device according to the invention provided with options.

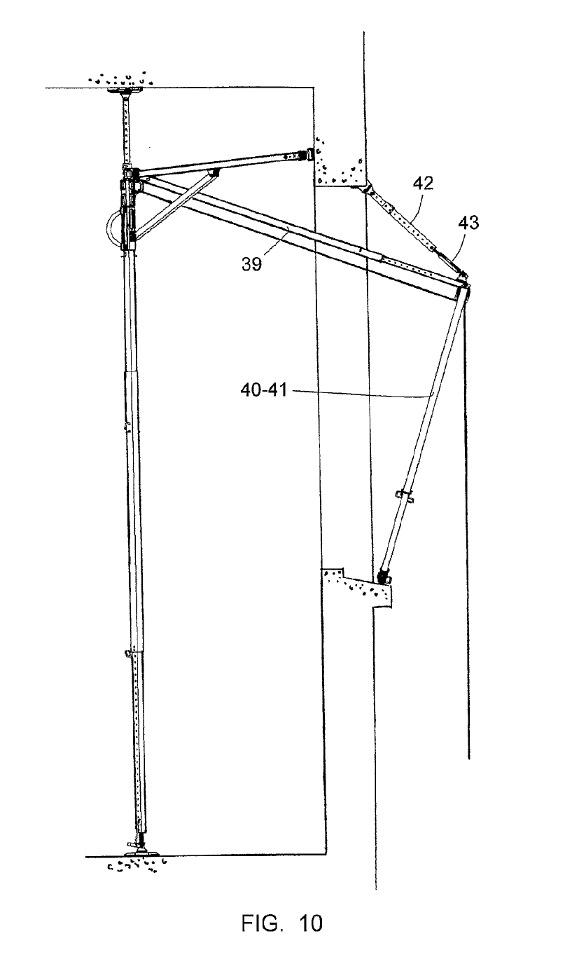

FIG. 10: side view of a variation of embodiment of an additional structure which the device may comprise.

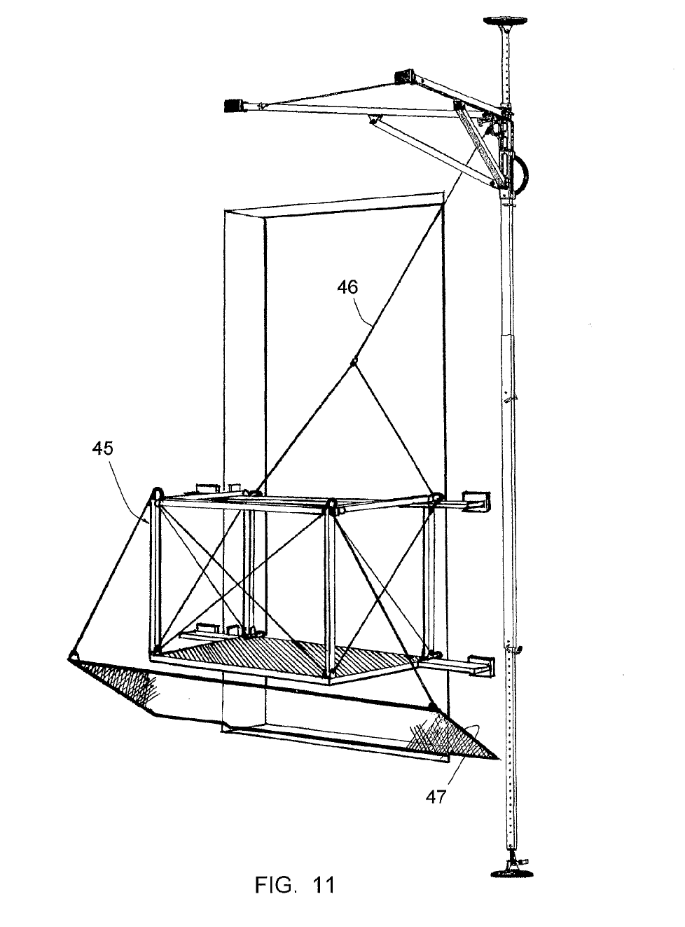

FIG. 11: perspective view of a console which the device may comprise.

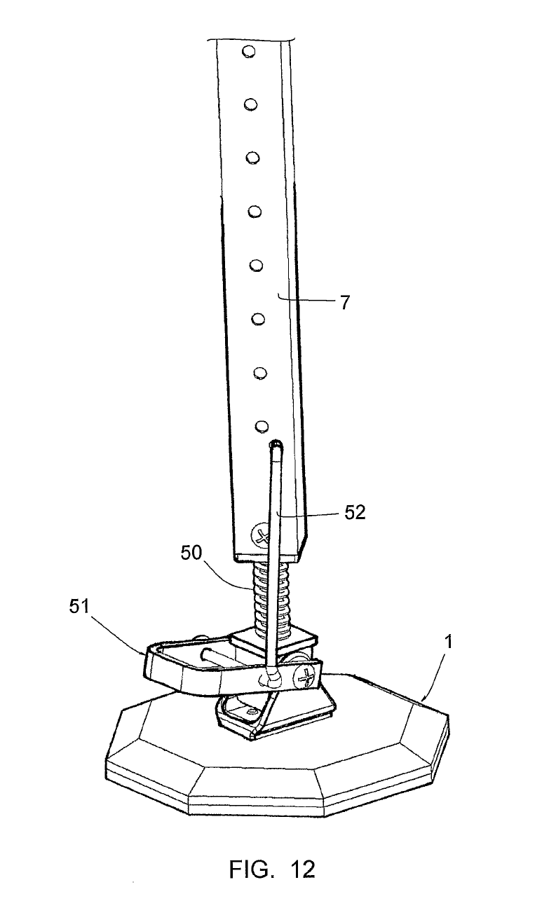

FIG. 12: variation of embodiment of a base which the device comprises.

FIG. 1 is a perspective view of the device according to the invention, from the inside of a building.

FIG. 2 is a side view of the lower portion of the device according to the invention. It is provided with a base (1) providing a support surface making it possible to distribute the load. Placed on the floor this base allows stability of the device during its assembly. The underside of this base may be provided with a small foam mat with a small thickness (2) able to prevent damaging the floors. On this base is secured a plate (3) on which a device is maintained allowing blocking and slight vertical pressuring of any structure from the top and from the bottom once the set of assembly operations are done. This vertical blocking can be done using a system such as a gas cylinder or any other system, in this case in FIG. 1 a mechanical system with reversed threadings of the turnbuckle type (4). A threaded rod (5), lower portion of the tightener is secured on the plate (3). A second threaded rod (6) making up the upper portion of the turnbuckle is secured at the end of a bar (7). In the upper portion of the bar (7), a hole (8) allows placement of a key (9).

FIG. 3 is a side view of the upper portion of the device according to the invention. It fits into the lower portion by sliding of the bar (10) inside the bar (7).

At the top of the bar (10), a hollow part (11) is secured inside which the bar (12) FIG. 4 of the raising part can move vertically, the latter part being immobilized using the blocking key (13) housed in the hole (14) located on top of the part (11).

On this hollow part (11) between the two arms (15) is the anchoring ring (16) FIGS. 1, 3 and 6 allowing hooking of the operator's PPE. The two arms (15) are articulated at one of their ends in (17) on the part (11) and several tens of centimeters from this articulation in (18), a bar forming a spacer (19) is articulated in (18) on the arm (15) and in (20) on the sliding hollow part (21).

The hollow part (21) allows, by its upward vertical movement along the bar (10) thereby abutting against the hollow part (11), the deployment of the two arms (15).

These two arms (15) sufficiently spaced apart from each other, in this case perpendicular to each other, are provided, at their other end, with articulations (22). These articulations receive “load distributing” pads (23) equipped with protective foam (24) bearing on either side of the opening on the inner wall of the worksite. The articulations (22) allow contact against a wall, regardless of its state and the folding of the structure.

These two arms (15) are connected to each other by a cable (25) FIG. 5 by two rings (26).

An elastic tightener (27) FIG. 5 connects the middle of the cable (25) at the top of the part (11) FIGS. 3 and 5 to a ring (29) facilitating bending of the cable during closing of the structure.

The arms (19) FIG. 3 articulated in two points (18) and (20) help opening and closing, by means of the handle (28) secured on the hollow part (21).

The blocking key (30) housed in the hole (31) locks the element (21) in the high position, thereby keeping both arms (15) supported by the arms (19) in the open position.

FIG. 4 is the side view of the element making it possible to raise the device according to the invention. Adjustment of its height is done by sliding its lower bar (12) inside the bar (10) and immobilizing it using one of the bores (32), located on the bar (12). This raising part is blocked by using the key (13) housed in the hole (14). This raising part is provided on top of a plate (33) able to be articulated, on which is secured a load distributing pad (34) equipped with foam (35), in order to avoid destroying the ceiling. This upper element FIG. 3 slides vertically via the bar (10) in the bar (7) until the foam (35) comes into contact with the ceiling. It is immobilized as close as possible thereto via a second blocking key (9) which is housed in the hole (8) on this bar (7) and in the closest hole available on the bar (10). The vertical blocking immobilizing the structure is done via the turnbuckle (4).

The anchoring ring (16) located on top FIGS. 1, 3, 5, 6:
prevents the rope from dragging on the ground, decreasing the risk of damage thereof
decreases, due to its position, the shock force absorbed by the anchoring and the fall factor, which thus cannot be greater than 1. One recalls that the shock force is much greater than the body weight. It can cause the breakage of the rope, cable or mooring or hurt the individual. There is a shock when the rope blocks the operator. Its value depends on the height of the fall. The fall factor is equal to the height of the fall divided by the length of rope used. This must be as low as possible.

This anchoring point allows the operator to be connected to the structure via his PPE before mounting the stepladder and to obtain support on the edge of the window or another high up opening.

For sites equipped with suspended ceilings, the raising part integrated into the upper element FIG. 2 slides vertically until it reaches the existing ceiling. Blocking by captive key (13) FIG. 3 equips this raising part, which allows plenums of large heights.

For sites with under-ceiling heights greater than three meters: an extender FIG. 7 made up of two coupled arms (36) and (37) fitting into the arms (7) and (10), respectively, makes it possible to raise the entire structure. An additional blocking key (38) allows its immobilization.

The structure FIG. 3, once folded FIG. 8, fits into an area corresponding to the lower and upper plates. It is stored in a bag provided with handles and/or straps allowing it to be transported as a backpack. It is easily transportable on the worksite thanks to its small weight.

The dimensions can be modified (decreased or increased) to meet the needs of less common scenarios.

The bulk of this structure can be reduced by half in terms of height once folded if it is made with arms (15) FIG. 8 and arms (10) FIG. 8 (7) FIG. 2 (37) FIG. 7 coupled to each other.

This structure can be provided with additional support points on the floor to increase its stability during assembly and disassembly.

A possible copy would consist of replacing the vertical blockage (turnbuckle), and the support point at the ceiling, by an additional set of legs and crosspieces limiting the interest of the system but nevertheless procuring the same advantages as the structure presented above. This structure would then be stable in itself, longer to implement, certainly more heavy and bulky but nevertheless can be higher performance because it does not require the presence of a support surface on top.

Another use of this device would consist, in other scenarios, of lifting loads from the street to the floor concerned by the work FIG. 9. By using a bar 39 connected from one side on top of the structure to the room (11) and at the other end with two arms (40) and (41) resting in two points on the edge of the window or the opening. These three arms are connected to each other by a connecting portion comprising, in its lower face, a lifting ring on which a return pulley could be installed. This pulley could be used as angle return. It could also be used to avoid friction of the wire used for insurance for an operator working down below the facade outside the building. All of this new structure FIG. 9 together with a hoist could be used as means for lifting loads from the ground.

FIG. 10 shows that the bar 39 can be a telescopic structure in order to be adjustable in length, and that the additional lifting structure formed by the bars 39 to 41 can be completed by an additional upper bar 42, connected to the part which makes it possible to assemble the bars 39 to 41 to each other and bearing on the edge of the wall of the building defining the bay in the upper portion. This bar 42 can have a telescopic structure in order to be adjustable in length and to be equipped with a tightener 43. The part which makes it possible to assemble the bars 39 to 42 to each other can comprise a pulley on which the lifting cable passes.

FIG. 11 shows that the device can also comprise a console 45 including a floor and railing, designed to be placed on the outside of the bay, this console 45 being connected to the device by at least one cable 46. A tool fall prevention net 47 can be stretched between the bay and the console 45.

FIG. 12 shows a variation of embodiment of the lower base 1. This base 1 comprises a vertical finger on which the telescopic element 7 is mounted with the possibility of vertical sliding in relation to this base. A spring 50 is engaged on the vertical finger while being inserted between the base 1 and the telescopic element 7. A pedal 51 is mounted pivoting on the base 1, and a rod 52 connects the pedal 51 and the telescopic element 7.

Actuation on the pedal 51 makes it possible, via the rod 52, to cause the telescopic element 7 to slide vertically against the elastic force of the spring 50 to make it possible to easily bring the telescopic element 7 into a determined sliding position in relation to the adjacent telescopic element 10. This determined sliding position can in particular be that in which the holes comprised by one of the telescopic elements 7 come across from the holes comprised by the other telescopic element 10, in order to make it possible to facilitate the insertion through these respective holes of an immobilization pin 9 of one telescopic element 7 in relation to the other.

1. Mobile anchoring and fall prevention device to making it possible to ensure the security of workers of any trade who operate from the inside of a building, on a wall, through a bay in said wall, while in the vicinity of empty spaces and without damaging the inner or outer existing structures (floor, wall, ceiling), characterized in that it comprises:
a rigid structure to be placed opposite the bay;
two arms connected to the upper part of the structure, intended to bear on the wall, above the bay and on either side thereof, and
an anchoring point integral with said structure, located at the upper portion thereof.

2. Device according to claim 1, characterized in that said structure comprises a single post intended to rest against the floor of the room in which the work is taking place and against the ceiling of this same room, said post being equipped with means for adjusting its length so as to apply its ends tightly against this floor and this ceiling, respectively.

3. Device according to claim 1, characterized in that said structure comprises two lateral posts intended to rest against the floor and a crosspiece connecting these two posts to each other.

4. Device according to claim 2, characterized in that said means for adjusting the length of said single post comprise:
two telescopic elements forming said post, able to be secured in a determined position in relation to each other, in particular by a system of holes arranged in these telescopic elements and a key, said determined position being such that, in this position, said post has a length slightly smaller than the distance separating the floor from the ceiling of the room where the work is taking place;
means for making fine adjustments to the length of said post, with the possibility of tightening, acting at the level of an end of this post, these adjustment means making it possible to achieve tight application of the ends of the post against the floor and the ceiling, respectively.

5. Device according to claim 1, characterized:
in that an arm is mounted pivoting in relation to the structure;
in that it comprises a portion engaged on a post of the structure with the possibility of sliding;
in that it comprises a spacer connected pivotingly to said arm and this sliding piece, and
in that it comprises a part secured on said post, forming a stop against which said sliding piece abuts in the deployed position of said arm.

6. Device according to claim 1, characterized in that each post of the structure comprises a bearing pad against the surface on which it is intended to rest.

7. Device according to claim 1, characterized in that each arm comprises, at its end opposite said structure, a bearing pad against the wall comprising the bay, articulated in relation thereto.

8. Device according to claim 1, characterized in that the two arms are, on the side opposite said structure, connected to each other by a cable, which limits any possibility of separation of one arm in relation to the other.

9. Device according to claim 8, characterized in that the cable is, at its central part, connected to an elastic tightener facilitating folding of the arms in relation to said structure.

10. Device according to claim 1, characterized in that it comprises rigid elements able to bear on the edges defining the bay, the additional structure formed by these rigid elements being connected to said structure of the device.

11. Device according to claim 10, characterized in that said additional structure can comprise a bar designed to bear on one of the edges defining the bay and preferably two bars, one of which is designed to bear against a lower edge defining the bay and the other of which is designed to bear against an upper edge defining the bay.

12. Device according to claim 1, characterized in that it comprises a console including a floor and a railing designed to be placed on the outside the bay, this console being connected to the rest of the device by an arm and/or a cable.

13. Device according to claim 4, characterized in that it comprises:
a lower base on which one of the telescopic elements is mounted, with the possibility of sliding in relation to this base,
a spring inserted between this base and this telescopic element
a pedal mounted pivoting on the base, and
a rod connecting the pedal and the telescopic element.
